(19) United States
(12) Patent Application Publication
(10) Pub. No.: US 2025/0247340 A1
(43) Pub. Date: Jul. 31, 2025

(54) SYSTEMS AND METHODS FOR OPTIMIZING BUFFER RESOURCE ALLOCATIONS IN A TARGET NETWORK

(71) Applicant: Walmart Apollo, LLC, Bentonville, AR (US)

(72) Inventors: Fiona Chehong Yeung, San Francisco, CA (US); John Penfield Bowman, El Cerrito, CA (US)

(21) Appl. No.: 18/427,702

(22) Filed: Jan. 30, 2024

(51) Int. Cl. H04L 47/83; H04L 47/762

(52) U.S. Cl. CPC H04L 47/83; H04L 47/762

(57) ABSTRACT

Systems and methods of generating resource allocation data structures for a target network are disclosed. A resource buffer optimization request is received for at least one distribution node and a plurality of demand nodes associated with the at least one distribution node for a selected resource, a demand probability distribution including one or more marginal stockout events for each of the plurality of demand nodes is determined, the one or more marginal stockout events for each of the plurality of demand nodes is ranked in a combined ranking, a constraint cutoff threshold is determined, and a resource buffer data structure including demand node resource buffer allocations for each of the plurality of demand nodes is generated. Each of the demand node resource buffer allocations include a marginal stockout event having a probability greater than the constraint cutoff threshold. The resource buffer data structure is stored in a data store.

### TECHNICAL FIELD

This application relates generally to determining resource distribution within a large-scale network, and more particularly, to determining target-specific resource distributions based on corresponding target demand within the large-scale network.

### BACKGROUND

Distribution of elements across large-scale networks, such as supply chain networks, can include a buffer amount for one or more distributed elements to prevent stock out conditions (e.g., unavailability of a resource due to overdemand and/or undersupply) of the corresponding element. In large-scale networks, the network and process limitations of simulation and/or planning processes currently restrict such networks to using generic resource targets and corresponding generic buffer values for each distributed resource.

As one example, current large-scale supply chain networks utilize resource-demand node pairs (e.g., item-store pairs), where each resource-demand node pair receives an inventory value for a corresponding resource based solely on the resource consumption at the demand node and the resource-demand node targets. Due to constraints imposed by large-scale networks, current processes utilize a generic target for each resource-demand node pair, such as a single target applied to all resources within a given category and all demand nodes at which the resource is consumed/stocked. Current distribution processes result in sub-optimal distribution of resources.

### SUMMARY

In various embodiments, a system including a non-transitory memory and a processor communicatively coupled to the non-transitory memory is disclosed. The processor is configured to read a set of instructions to receive a resource buffer optimization request for at least one distribution node and a plurality of demand nodes associated with the at least one distribution node for a selected resource, determine a demand probability distribution including the probabilities of one or more marginal stockout events for each of the plurality of demand nodes, rank the one or more marginal stockout events for each of the plurality of demand nodes in a combined ranking, determine a constraint cutoff threshold, and generate a resource buffer data structure including demand node resource buffer allocations for each of the plurality of demand nodes. Each of the demand node resource buffer allocations include a marginal stockout event having a probability greater than or equal to the constraint cutoff threshold. The processor is further configured to read the set of instructions to store the resource buffer data structure in a data store.

In various embodiments, a computer-implemented method is disclosed. The computer-implemented method includes steps of receiving a resource buffer optimization request for at least one distribution node and a plurality of demand nodes associated with the at least one distribution node for a selected resource, determining a demand probability distribution including the probabilities of one or more marginal stockout events for each of the plurality of demand nodes, ranking the one or more marginal stockout events for each of the plurality of demand nodes in a combined ranking, determining a constraint cutoff threshold, and generating a resource buffer data structure including demand node resource buffer allocations for each of the plurality of demand nodes. Each of the demand node resource buffer allocations include a marginal stockout event having a probability greater than or equal to the constraint cutoff threshold. The computer-implemented method further includes a step of storing the resource buffer data structure in a data store.

In various embodiments, a non-transitory computer-readable medium having instructions stored thereon is disclosed. The instructions, when executed by at least one processor, cause at least one device to perform operations including receiving a resource buffer optimization request for at least one distribution node and a plurality of demand nodes associated with the at least one distribution node for a selected resource, determining a demand probability distribution comprising a probability mass function including the probabilities of one or more marginal stockout events for each of the plurality of demand nodes, ranking the one or more marginal stockout events for each of the plurality of demand nodes in a combined ranking, determining a constraint cutoff threshold, and generating a resource buffer data structure including demand node resource buffer allocations for each of the plurality of demand nodes. Each of the demand node resource buffer allocations include a marginal stockout event having a probability greater than or equal to the constraint cutoff threshold. The instructions further cause the at least one device to perform operations including storing the resource buffer data structure in a data store.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide target-specific distribution for large-scale networks, in accordance with some embodiments;

FIG. 2 illustrates a computer system configured to implement one or more processes, in accordance with some embodiments;

FIG. 3 is a flowchart illustrating a resource buffer optimization method, in accordance with some embodiments;

FIG. 4 is a process flow illustrating various steps of the resource buffer optimization method of FIG. 3, in accordance with some embodiments;

FIG. 5 is a graph representation of a target network, in accordance with some embodiments;

FIG. 6 illustrates a demand probability estimation method, in accordance with some embodiments;

FIGS. 7A and 7B illustrate example node-specific demand distributions and corresponding resource node-exhaustion regions for a first demand node and a second demand node respectively, in accordance with some embodiments;

FIG. 8A illustrates incremental probability sets for a set of demand nodes associated with a selected distribution node for a first resource, in accordance with some embodiments;

FIG. 8B illustrates the incremental probability sets of FIG. 8A combined into a single ranked incremental probability set including each of the individual incremental probabilities in a ranked order, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for determining demand node specific buffer resource values. In various embodiments, a distribution network data structure is defined. The distribution network includes a distribution node and two or more demand nodes. A demand node specific buffer resource value is generated for each of the two or more demand nodes. In some embodiments, a network wide and/or distribution node specific resource fill target is determined. A resource fill target is subsequently generated for each of the two or more demand nodes. A buffer stock analysis process is implemented to determine a required buffer stock of a predetermined resource at each of the two or more demand nodes. The demand node specific resource requirements are converted into a distribution node resource requirement and final buffer stock values assigned to the distribution node and/or each of the two or more demand nodes.

In some embodiments, systems, and methods for determining demand node specific buffer resource values includes one or more trained analysis models. The trained analysis models may include one or more models, such as one or more models configured to implement a buffer stock analysis process. The buffer stock analysis process may include a marginal analysis configured to determine a demand node specific buffer stock requirement. In some embodiments, the trained analysis model is configured to determine optimal individual demand node resource fill rates that may be aggregated to generate distribution node fill rates.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

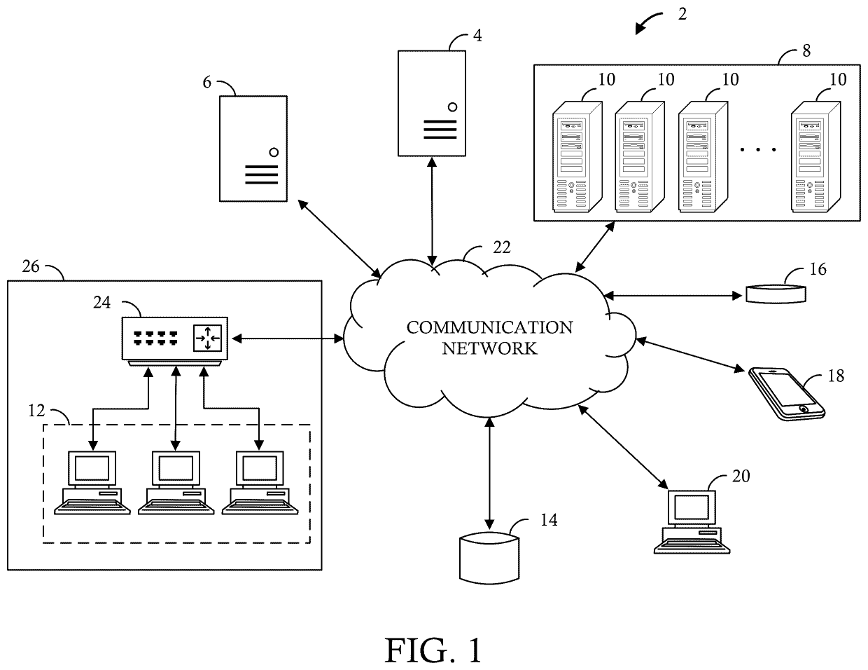

FIG. 1 illustrates a network environment 2 configured to provide demand node specific buffer resource values, in accordance with some embodiments. The network environment 2 includes a plurality of devices or systems configured to communicate over one or more network channels, illustrated as a network cloud 22. For example, in various embodiments, the network environment 2 may include, but is not limited to, a resource buffer optimization computing device 4, a web server 6, a cloud-based engine 8 including one or more processing devices 10, workstation(s) 12, a database 14, and/or one or more user computing devices 16, 18, 20 operatively coupled over the network 22. The resource buffer optimization computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the resource buffer optimization computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines and/or execute on one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the resource buffer optimization computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the resource buffer optimization computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the resource buffer optimization computing device 4, for example. The workstation(s) 12 may communicate with the resource buffer optimization computing device 4 over the communication network 22. The workstation(s) 12 may send data to, and receive data from, the resource buffer optimization computing device 4. For example, the workstation(s) 12 may transmit data related to tracked operations performed at the physical location 26 to resource buffer optimization computing device 4.

Although FIG. 1 illustrates three user computing devices 16, 18, 20, the network environment 2 may include any number of user computing devices 16, 18, 20. Similarly, the network environment 2 may include any number of the resource buffer optimization computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the resource buffer optimization computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

In some embodiments, the resource buffer optimization computing device 4 may execute one or more models, processes, or algorithms, such as a machine learning model, deep learning model, statistical model, etc., to generate and/or determine optimal distribution node and/or demand node specific resource buffer values. The resource buffer optimization computing device 4 is further operable to communicate with the database 14 over the communication network 22. For example, the resource buffer optimization computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the resource buffer optimization computing device 4, in some embodiments, the database 14 may be a local storage device, such as a hard drive, a non-volatile memory, or a USB stick.

In some embodiments, the resource buffer optimization computing device 4 assigns the execution of one or more modules, elements, etc. to one or more processing devices 10. For example, each module, element, etc. may be assigned to a virtual machine hosted by a processing device 10. The virtual machine may cause the models or parts thereof to execute on one or more processing units such as GPUs. In some embodiments, the virtual machines assign each module, element, etc. (or part thereof) among a plurality of processing units.

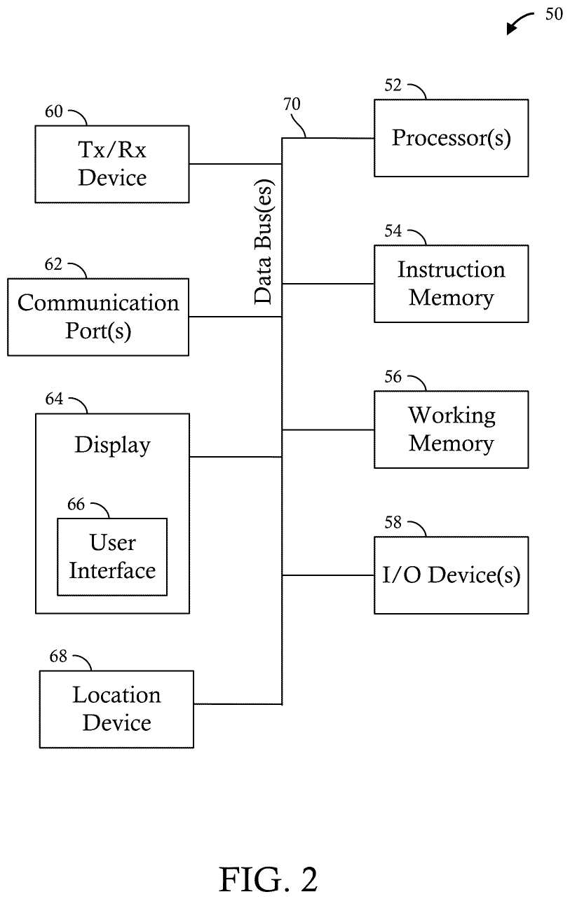

FIG. 2 illustrates a block diagram of a computing device 50, in accordance with some embodiments. In some embodiments, each of the resource buffer optimization computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for determining and/or generating optimal distribution node and/or demand node specific resource buffer values, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with generated resource buffer values and/or assignments. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

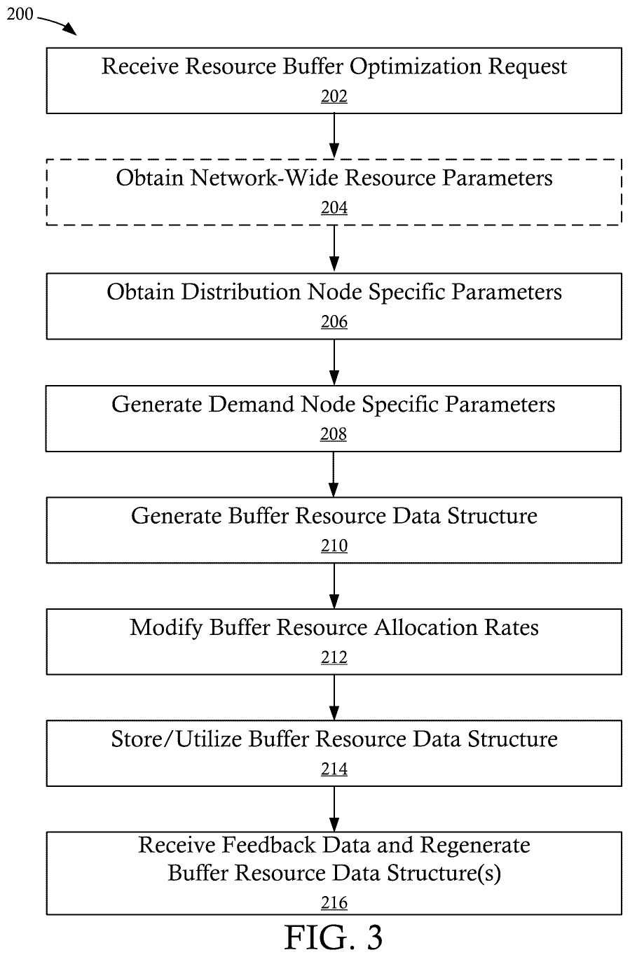

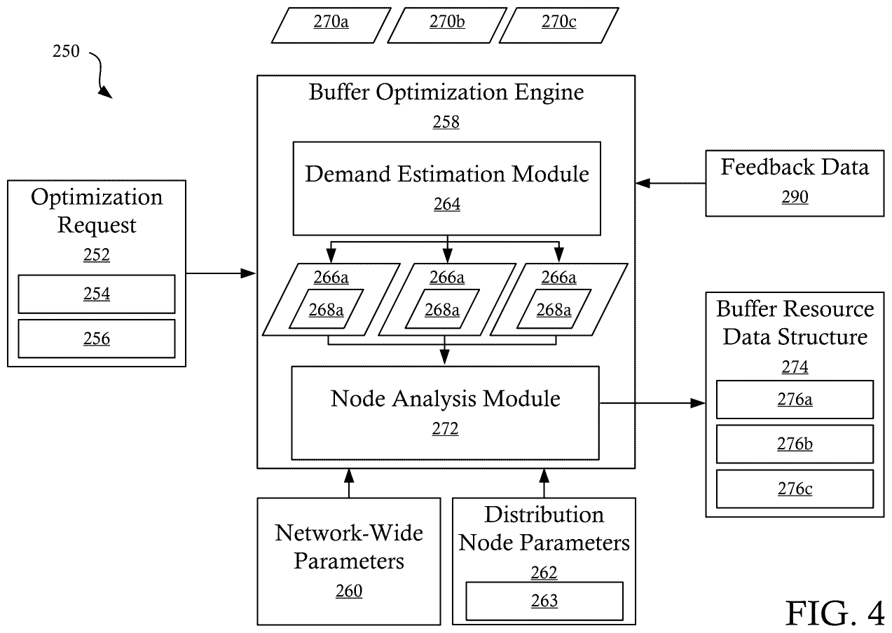

FIG. 3 is a flowchart illustrating a resource buffer optimization method 200, in accordance with some embodiments. FIG. 4 is a process flow 250 illustrating various steps of the resource buffer optimization method 200, in accordance with some embodiments. The resource buffer optimization method 200 may be applied periodically and/or dynamically to generated optimized buffer resource distributions, e.g., optimized network data structures including data elements representative of optimized buffer resource distributions for each distribution node and/or demand node within the optimized network data structure. The resource buffer optimization method 200 provides an improved buffer resource allocation process that applies individual and specific distribution and/or demand node historical data, simulations, and/or buffer resource allocation specifications.

At step 202, a resource buffer optimization request 252 is received. The resource buffer optimization request 252 may be generated by any suitable system. For example, in some embodiments, the resource buffer optimization request 252 may be generated by a web server 6, a workstation 12, and/or a user computing device 16, 18, 20 in response to one or more interactions with an optimization and/or simulation interface. The resource buffer optimization request 252 may be received by any suitable system, device, engine, module, etc., such as, for example, a resource buffer optimization engine 258. The resource buffer optimization request 252 may include a request to generate an optimized distribution fulfillment data structure representing an optimized distribution fulfillment plan for at least a portion of a target distribution network including optimized buffer allocations for one or more resources.

The resource buffer optimization request 252 may include network data 254 defining and/or identifying a target distribution network and/or a portion of a target distribution network. For example, in some embodiments, the network data 254 includes an in-memory representation of a target network. As another example, in some embodiments, the network data 254 includes an identifier utilized by the resource buffer optimization engine 258 to retrieve an in-memory representation of a target network from a data source, such as database 14. As yet another example, in some embodiments, the network data 254 includes one or more parameters and/or identifiers to configure the resource buffer optimization engine 258 to generate an in-memory representation of a target network. Although specific embodiments are discussed herein, it will be appreciated that any suitable process and/or method may be used to obtain an in-memory representation of a target network as part of a resource buffer optimization method 200.

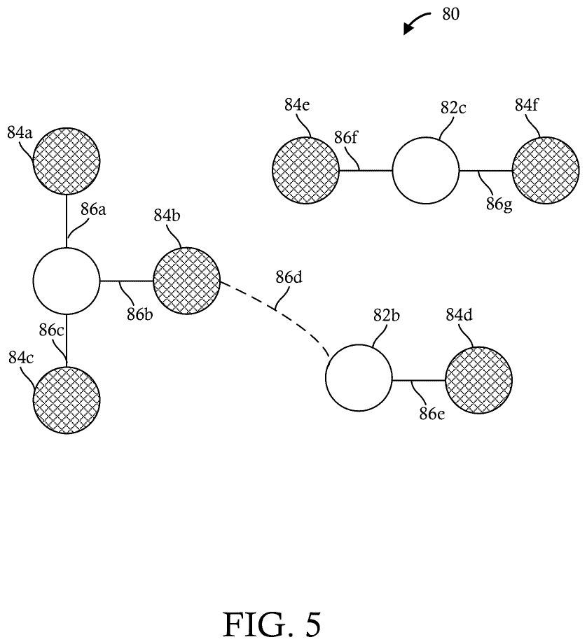

FIG. 5 illustrates a graph representation of an example target network 80, in accordance with some embodiments. The graph representation of the target network 80 includes a multipartite graph including a plurality of distribution nodes 82a-82c (collectively “distribution nodes 82”), a plurality of demand nodes 84a-84f (collectively “demand nodes 84”), and a plurality of distribution channels 86a-86g (collectively “distribution channels 86”). Each of the distribution nodes 82 represent a distribution location or element within the target network 80 that provides at least one resource to one of the demand nodes 84 within the target network 80 and each of the demand nodes 84 represent a demand location or element within the target network 80 that receives and/or consumes resources.

In some embodiments, one or more of the demand nodes 84 may be connected to (e.g., serviced by) two or more of the distribution nodes 82. For example, as shown in the illustrated embodiment, the second demand node 84b may be serviced by the first distribution node 82a and/or by the second distribution node 82b. The demand of the second demand node 84b may be allocated to only one of the connected distribution nodes, e.g., only one of the first distribution node 82a or the second distribution node 82b, and/or may be partially allocated to the first distribution node 82a and partially allocated to the second distribution node 82b. In some embodiments, the second demand node 84b may receive one or more first resources from a first distribution node 82a and one or more second resources from a second distribution node 82b.

In some embodiments, the network data 254 may include one or more node features and/or parameters representative of a resource available at a corresponding one of the distribution nodes 82. For example, in some embodiments, each of the distribution nodes 82 include one or more limited resources that may be utilized (e.g., consumed) during fulfillment of demand allocated to the corresponding one of the distribution nodes 82. As one example, in some embodiments including a target supply chain network, each of the distribution nodes 82 may include capacities or stock values representative of the volume (e.g., unit count) of one or more items available from the distribution node 82.

In some embodiments, the network data 254 may include one or more node features and/or parameters representative of a consumption or use rate for a resource at a corresponding one of the demand nodes 84. For example, to continue the supply chain example from above, a first demand node 84a in a target supply-chain network may utilize a first resource, e.g., a first item inventory, at a first rate and a second demand node 84b may utilize the first resource, e.g., the first item inventory, at a second rate. The rate of utilization for a resource may include a fixed rate and/or may include a variable rate over time.

In some embodiments, the target network 80 is representative of at least a portion of a large-scale supply chain distribution network. In such embodiments, the distribution nodes 82 are representative of distribution locations (e.g., warehouses) configured to service supply demand of demand nodes 84 representative of supply chain demand consumers (e.g., retail stores, local consumers, etc.), and the distribution channels 86 may be representative of a supply chain distribution channels (e.g., freight shipping, on-demand shipping, etc.). It will be appreciated that these embodiments are exemplary and additional networks may be modeled and/or optimized by the resource buffer optimization computing device 4.

In some embodiments, a target supply chain network may include brick-and-mortar supply chain locations and/or processes (e.g., in-store stocking, sales, tracking, warehousing, distribution locations, receiving locations, etc.) and/or online supply chain processes (e.g., distributed stock tracking, internet-based sales or interactions, delivery processes, third-party merchant processes, online distribution locations, customer delivery locations, etc.). The resource buffer optimization computing device 4 may be configured to receive a plurality of inputs, for example, from processing device(s) 10, workstation(s) 12, database 14, one or more user computing devices 16, 18, 20, etc. representative of a historical and/or current state of the supply chain network (e.g., state of each node and/or channel). The resource buffer optimization computing device 4 is configured to receive any suitable type of input, such as, for example, a heuristic input, a statistical input, a deep learning generated input, etc. suitable for incorporation into a distribution network optimization process, as discussed herein.

With reference again to FIGS. 3-4, in some embodiments, the resource buffer optimization request 252 may include resource data 256 defining at least one selected resource for buffer optimization. For example, the resource data 256 may identify at least one selected resource provided by at least one of the distribution nodes 82 to at least one of the demand nodes 84 within the target network 80. In the context of a large-scale supply chain network, the resource data 256 may identify an item supplied by one of the distribution nodes 82 to one or more of the demand nodes 84. Although embodiments are discussed herein including a single selected resource, it will be appreciated that the resource data 256 may identify two or more resources for simultaneous and/or sequential optimization. Buffer optimization for each of the two or more resources may be performed in parallel and/or in series in various embodiments.

In some embodiments, the network data 254 may include parameter data defining operational parameters, constraints, costs, etc. for optimization of the target network 80 and/or a portion of the target network 80. For example, in some embodiments, the parameter data includes one or more parameters defining a scope of an operation of a target network 80. For example, in some embodiments, the parameter data can include a time frame parameter (e.g., past-simulation, present or near-term simulation, future simulation, etc.), a granularity parameter (e.g., coarse granularity, medium granularity, fine granularity, etc.), a fidelity parameter (e.g., low fidelity, medium fidelity, high fidelity, etc.), demand generation parameters (e.g., parameters related to the demand to be simulated), network inputs (e.g., parameters defining certain structural elements of the simulated process or network), constraint parameters (e.g., parameters constraining the simulation or the system during simulation), etc. The parameter data may additionally and/or alternatively include parameters defining a target output of the target network 80, such as, for example, a target demand, a target cost, a target value, etc. Although specific embodiments are discussed herein, it will be appreciated that any suitable input parameters, such as required or optional parameters, for the simulation can be included in the parameter data.

In some embodiments, the network data 254 identifies a selected distribution node, such as distribution node 82a and the resource data 256 identifies a selected resource, such as a first resource, selected for resource buffer optimization. For example, in some embodiments, the network data 254 defines and/or is representative of a portion of the target network 80 including the first distribution node 82a and each of the demand nodes 84a-84c that receive the first resource from the first distribution node 82a. As another example, in some embodiments, the network data 254 defines and/or is representative of a portion of the target network 80 including two or more of the distribution nodes 82. The first distribution node 82a may be selected for optimization as part of a node-by-node optimization. The corresponding demand nodes 84a-84c may be selected or identified based on the identification of the first distribution node 82a and the first resource identified in the resource data 256. Although specific embodiments are discussed herein, it will be appreciated that a selected distribution node and/or a selected resource may be selected and/or identified utilizing any suitable process. Further, although embodiments are discussed herein including a selected distribution node and a selected resource, it will be appreciated that the disclosed systems and methods may be used to optimize resource buffer allocation for multiple distribution node-demand node sets and/or multiple resources simultaneously and/or sequentially.

At optional step 204, one or more network-wide parameters 260 may be received and/or generated. The network-wide parameters 260 include network-wide constraints and/or requirements for a specific resource. For example, network-wide parameters 260 may require that a first resource be available (e.g., filled) within the network at a first fill rate, a second resource be available at a second fill rate, etc. As another example, network-wide parameters 260 may divide a network into various portions (e.g., zones, areas, etc.) and define portion-specific fill rates for one or more resources. The network-wide parameters 260 may be received as separate data, e.g., from a data store or other data repository, and/or may be included in the network data 254 included in the resource buffer optimization request 252. Although specific embodiments are discussed herein, it will be appreciated that any suitable network-wide parameters 260 may be defined and/or received.

In some embodiments, the network-wide parameters 260 may be generated based on historical data and/or simulation of the target network 80. For example, in some embodiments, the network-wide parameters 260 may be based on historical fill and/or use rates of a selected resource within the target network 80. As another example, in some embodiments, the network-wide parameters 260 may be based on predicted use rates for the target network 80 based on one or more simulations of the target network 80. The network-wide parameters 260 may be generated by an automated process, a manual process, and/or a hybrid process. In some embodiments, the network-wide parameters 260 are based, at least in part, on one or more network operational rules.

At step 206, distribution node specific parameters 262 may be received and/or generated. The distribution node specific parameters 262 include constraints and/or requirements for a selected distribution node 82a. For example, distribution node specific parameters 262 for a selected distribution node 82a may require that a first resource be available (e.g., filled) at the distribution node at a first fill rate, a second resource be available at a second fill rate, etc. As another embodiment, the distribution node specific parameters 262 may define node constraints such as the number of units available for resource fill and/or buffer resource allocation for the selected distribution node 82a. The distribution node specific parameters 262 may be received as separate data, e.g., from a data store or other data repository, and/or may be included in the network data 254 included in the resource buffer optimization request 252. Although specific embodiments are discussed herein, it will be appreciated that any suitable distribution node specific parameters 262 may be defined and/or received.

In some embodiments, the distribution node specific parameters 262 may be generated based on historical data and/or simulation of the target network 80 and/or corresponding distribution node 82a. For example, in some embodiments, the distribution node specific parameters 262 may be based on historical fill and/or use rates of a selected resource at the selected distribution node 82a. As another example, in some embodiments, the distribution node specific parameters 262 may be based on predicted use rates for the target network 80 and/or the target distribution node 82a based on one or more simulations of the target network 80. The distribution node specific parameters 262 may be generated by an automated process, a manual process, and/or a hybrid process. In some embodiments, the distribution node specific parameters 262 are based, at least in part, on one or more distribution node operational rules.

In some embodiments, the distribution node specific parameters 262 include a total buffer resource volume 263. For example, the total buffer resource volume 263 may be representative of a buffer allocation of a selected resource to the selected distribution node 82a that includes an volume of the first resource specifically identified and/or provided for resource buffer distribution. As another example, the distribution node specific parameters 262 may include a total amount of a first resource that is provided to and/or available at the selected distribution node 82a for distribution to the corresponding demand nodes 84a-84c and a total buffer resource volume 263 may be determined based on a difference between a pre-allocated resource distribution (e.g., a minimum distribution requirement for each demand node 84a-84c associated with the distribution node 82a) and the total resource volume available at the selected distribution node 82a.

At step 208, demand node specific parameters 266a-266c (collectively “demand node specific parameters 266”) are generated for each demand node 84a-84c serviced by the selected distribution node 82a for the selected resource. The demand node specific parameters 266 may include demand node specific constraints, requirements, etc. for each of the demand nodes 84a-84c. In some embodiments, the demand node specific parameters 266 include a node-specific demand distribution 268a-268c (collectively “node-specific demand distributions 268”). The node-specific demand distributions 268 may be generated for a selected lead period and/or a selected review period for the selected resource. In some embodiments, a demand value of the selected resource over each of lead period in a set of lead periods may be considered a value of a discrete random variable. For example, where the predetermined lead period is one week, a demand value for a resource over each week within a review period may be considered a discrete random variable of the review period. The node-specific demand distributions 268 may include any suitable format, such as, for example, a probability mass function (PMF).

In some embodiments, each of the node-specific demand distributions 268 for each demand node 84a-84c may be generated by a demand estimation module 264 of the resource buffer optimization engine 258. The demand estimation module 264 may be configured to receive at least a portion of the network data 254 including identification of and/or parameters associated with a target distribution node 82a and one or more demand nodes 84a-84c associated with the target distribution node 82a for the selected resource. The demand estimation module 264 may be include one or more trained models and/or algorithms configured to generate one or more demand estimations for each demand node 84a-84c for the selected resource.

In some embodiments, the demand estimation module 264 receives one or more resource exhaustion signals 270a-270c (collectively “resource exhaustion signals 270”) (e.g., stockout signals, resource use signals, current resource volume signals, etc.) from each demand node 84a-84c associated with the selected distribution node 82a for the selected resource. The resource exhaustion signals 270 may be received individually from each of the demand nodes 84a-84c and/or may be network signals monitored and/or generated by other portions of a network, such as a central monitoring system, a simulation system, etc. In some embodiments, the resource exhaustion signals 270 are representative of resource usage across each demand node 84a-84c associated with a selected distribution node 82a.

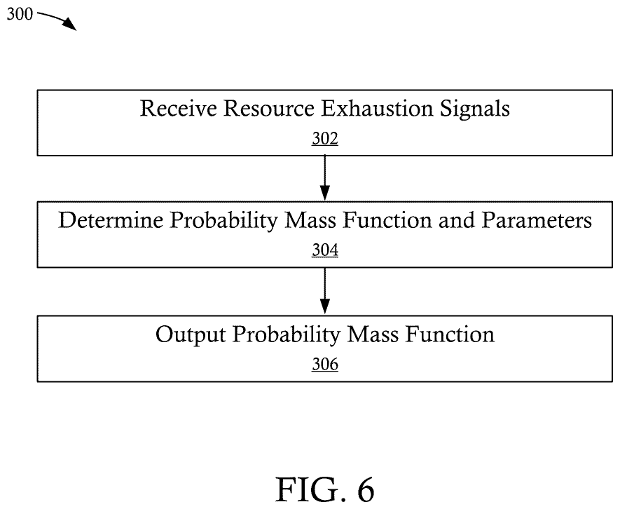

FIG. 6 illustrates a demand probability estimation method 300, in accordance with some embodiments. The demand probability estimation method 300 may be implemented by any suitable engine, module, etc., such as, for example, the demand estimation module 264. At step 302, resource exhaustion signals 270, including resource consumption data, is received for each demand node 84a-84c associated with (e.g., serviced by) a selected (e.g., target) distribution node 82a. Resource consumption data is representative of the use and/or consumption of a selected resource over predetermined lead times during a prior historical period. For example, in embodiments including a large-scale supply chain network, the resource exhaustion signals 270 may be representative of inventory usage for a specific item stocked by each of the demand nodes 84a-84c for one or more prior lead times.

At step 304, a node-specific demand distribution 268a-268c including a PMF for each demand node 84a-84c associated with the selected distribution node 82a is determined. For example, a PMF may include and/or be represented by any suitable function, such as, a negative binomial distribution, a Poisson distribution, etc. In some embodiments, a first distribution, such as a negative binomial distribution, is applied when a condition on a first set of parameters are met (e.g., variance>mean) and a second distribution, such as a Poisson distribution, is applied when the condition on the first set of parameters are not met. In some embodiments, parameters of a PMF are estimated based on historical demand of the corresponding demand node 84a over a predetermined time period. For example, in some embodiments, the parameters are estimated based a prior period including 3 months, 6 months, 9 months, 13 weeks, 26 weeks, etc.

In some embodiments, a discrete random variable representative of a demand value for the selected resource over each lead period within a review period is defined as:

D˜f(μ_{usage},s_{usage},μ_{lead time},s_{lead time})

where μ is a mean and s is a standard deviation of the usage or lead period observed from a prior period, respectively, and f(·) is the PMF that defines a demand distribution. In some embodiments, the parameters of the PMF may be estimated based on a predetermined review period. For example, in embodiments including a lead period measured in days, the review period may include a predetermined number of prior months, such as 6 months, 9 months, etc. Although specific embodiments are discussed herein, it will be appreciated that any suitable distribution may be used.

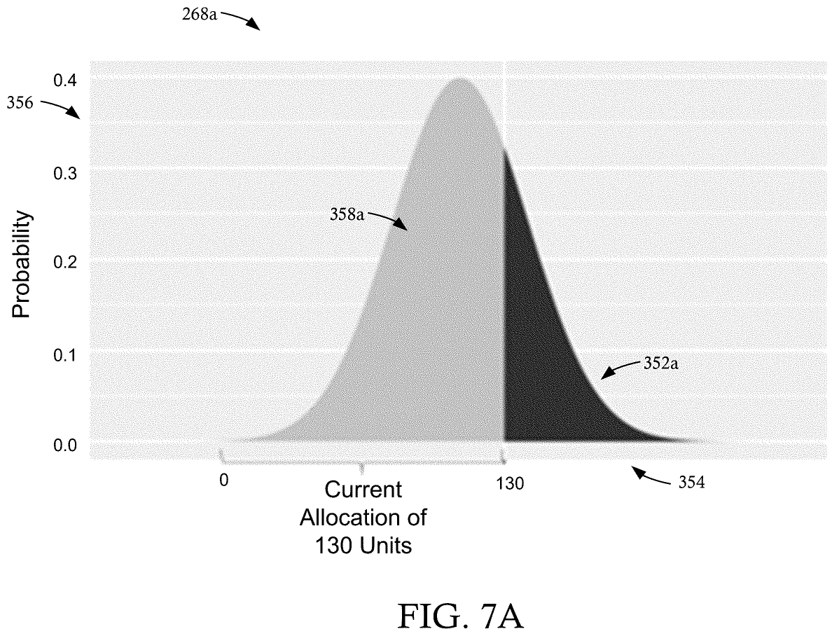

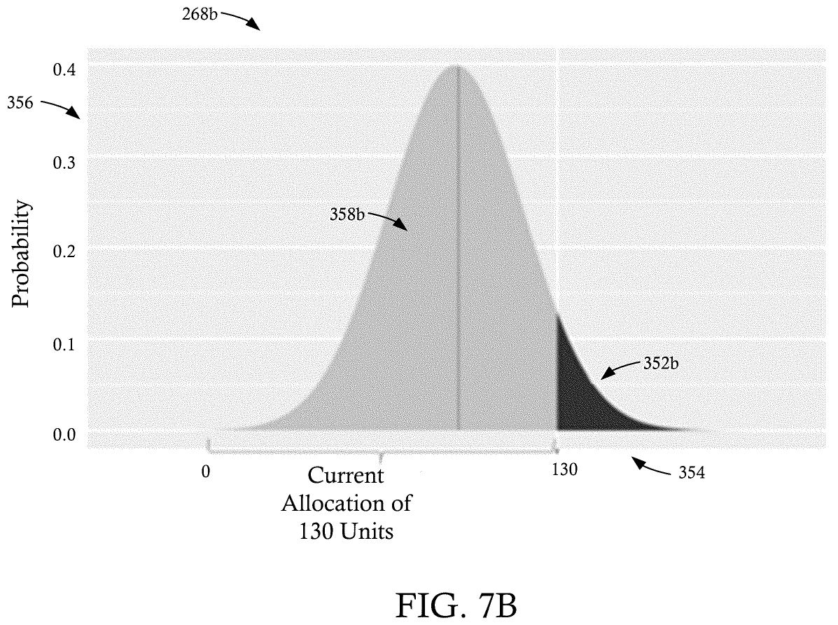

FIGS. 7A and 7B illustrate example node-specific demand distributions 268a, 268b and corresponding resource node-exhaustion regions 352a, 352b for a first demand node and a second demand node respectively, in accordance with some embodiments. The x-axis 354 represents a buffer resource quantity in units and the y-axis 356 represents the probability of the demand over the lead time and review period. A current resource value 358a, 358b indicates a current inventory or amount of the selected resource available (e.g., on hand) at the corresponding demand node (e.g., first demand node, second demand node). The resource node-exhaustion regions 352a, 352b for each corresponding node-specific demand distributions 268a, 268b includes the area to the right of the current resource value 358a, 358b. The resource node-exhaustion regions 352a, 352b represent a probability of demand exceeding supply during the lead time and review period, e.g., represents the demand at which the allocated amount of the selected resource is insufficient to protect the demand node 84a from a stockout event of the corresponding resource.

As illustrated in FIGS. 7A and 7B, the node-specific demand distributions 268a, 268b for different demand nodes, e.g. first demand node 84a and second demand node 84b, may have the same standard deviation. However, a demand node having a higher historical resource use value (e.g., first demand node 84a) produces a first node-specific demand distributions 268a including a resource node-exhaustion region 352a that is larger as compared a resource node-exhaustion region 352b of a second node-specific demand distributions 268b corresponding to a second demand node having a lower historical resource use value (e.g., second demand node 84b).

With reference again to FIG. 6, at step 306, the demand node specific parameters 266, including node-specific demand distributions 268a-268c, for each demand node 84a-84c are output. The output of the demand estimation module 264 is provided for use by one or more subsequent engines and/or modules, for example, the node analysis module 272, in determining marginal stockout probabilities as discussed in greater detail below. In some embodiments, the demand node specific parameters 266 and/or sub-elements thereof (e.g., the node-specific demand distributions 268a-268c) may be stored in one or more data stores, such as, for example, a database 14.

With reference again to FIGS. 3-5, at step 210, a buffer resource data structure 274 is generated. The buffer resource data structure 274 includes buffer resource allocation quantities 276a-276c (collectively “buffer resource allocation quantities 276”) for each corresponding demand node 84a-84c associated with the selected distribution node 82a for the selected resource data 256 corresponding to the buffer resource data structure 274. In some embodiments, the buffer resource data structure 274 is generated by proportionally allocating the total buffer resource volume 263 (e.g., the total buffer resource volume 263 associated with the selected distribution node 82a) to each of the demand nodes 84a-84c based on utilization of the selected resource at the corresponding demand node 84a-84c. Proportional allocation allocates a higher percentage of total buffer resource volume 263 to demand nodes 84a-84c having a higher demand, e.g., demand nodes 84a-84c that are at a higher risk of a stockout event. In some embodiments, a node analysis module 272 is configured to apply one or more processes to generate a buffer resource data structure 274.

In some embodiments, the buffer resource data structure 274 is generated by applying marginal reduction analysis to allocate the total buffer resource volume 263 for the corresponding distribution node 82a to each of the associated demand nodes 84a-84c. An incremental probability of a stockout event may be determined for each increment of 1 unit (e.g., 1 distribution value of a corresponding resource) between a minimum resource volume and a maximum resource volume for each associated demand node 84a-84c. In some embodiments, the minimum resource volume and/or the maximum resource volume may be determined and/or generated from historical resource volumes of the corresponding demand node 84a-84c, set as a parameter of the corresponding demand node 84a-84c, and/or generated according to any suitable process. The minimum resource volume and/or the maximum resource volume may be determined at an individual demand node 84a-84c and/or set at a distribution node 82a (e.g., all associated demand nodes 84a-84c have the same minimum and maximum resource volumes).

For example, in some embodiments, a first demand node 84a having a first node-specific demand distribution 268a may have four increments between a minimum resource volume and a maximum resource volume, resulting in four associated incremental probabilities (e.g., a first incremental probability for a stockout event corresponding to one unit required beyond the current stock value, a second incremental probability for a stockout event corresponding to two units required beyond the current stock value, and a third incremental probability for a stockout event corresponding to three units required beyond the current stock value, and a fourth incremental probability for a stockout event corresponding to four units required beyond the current stock value (and corresponding to a maximum resource volume). As another example, a second demand node 82b and a third demand node having a second node-specific demand distribution 268b and a third node-specific demand distribution 268c, respectively, may each have three associated incremental probabilities.

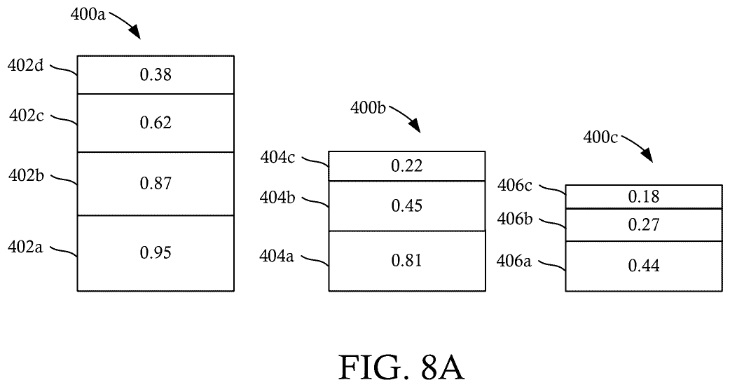

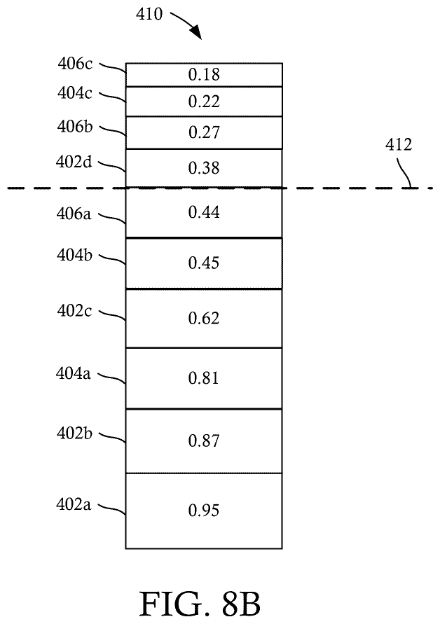

In some embodiments, the resource buffer volume of a first resource for the selected distribution node 82a may be allocated to each of the associated demand nodes 84a-84a based on a ranking of the incremental probabilities for the associated demand nodes 84a-84b. For example, FIG. 8A illustrates incremental probability sets 400a-400c for a set of demand nodes 84a-84c associated with a selected distribution node 82a for a first resource, in accordance with some embodiments. Each incremental probability set 400a-400c includes individual incremental probabilities 402a-402d, 404a-404c, 406a-406c associated with the incremental resource volumes between a minimum resource volume and a maximum resource volume for the corresponding demand node 84a-84c. Although embodiments are discussed herein including specific probability values, it will be appreciated that these values are merely exemplary and provided solely for discussion purposes.

In the example of FIG. 8A, the first incremental probability set 400a includes a first incremental probability value 402a of 0.95, a second incremental probability value of 402b 0.87, a third incremental probability value 402c of 0.62, and a fourth incremental probability value 402d of 0.38. Each of the incremental probability values represent a likelihood of a stockout event associated with an incremental increase in demand units for the selected resource. For example, continuing the example of FIG. 8A, a first demand node 82a has a probability of 0.95 of a stockout event occurring for one unit above the minimum allocation amount (e.g., there is a 95% likelihood that one additional unit of the selected resource will be required within the forecast period), a 0.87 probability of a stockout event occurring for two units above the minimum allocation amount (e.g., there is an 87% likelihood that two additional units of the selected resource will be required within the forecast period), a 0.62 probability of a stockout event occurring for three units above the minimum allocation amount (e.g., there is an 62% likelihood that three additional units of the selected resource will be required within the forecast period), and a 0.38 probability of a stockout event occurring for four units above the minimum allocation amount (e.g., there is an 38% likelihood that four additional units of the selected resource will be required within the forecast period). The second incremental probability set 400b and the third incremental probability set 400c each similarly include incremental probabilities 404a-404c, 406a-406c corresponding to a likelihood of a stockout event occurring in the forecast period.

In some embodiments, the incremental probabilities 402a-402d, 404a-404c, 406a-406c for each demand node 84a-84c associated with a selected distribution node 82a may be ranked. For example, as shown in FIG. 8B, the incremental probability sets 400a-400c may be combined into a single ranked incremental probability set 410 including each of the individual incremental probabilities 402a-402d, 404a-404c, 406a-406c in a ranked order. Although the embodiment in FIGS. 8A & 8B illustrates an ascending ranked order, it will be appreciated that a descending ranked order may similarly be applied.

In some embodiments, the total buffer resource volume 263 is incrementally allocated to each of the demand nodes 84a-84c based on the ranked incremental probability set 410. For example, a first unit of the total buffer resource volume 263 may be allocated to the lowest ranked (e.g., highest probability) incremental probability 402a, a second unit of the total buffer resource volume 263 to the second-lowest ranked (e.g., second-highest probability) incremental probability 402b, a third unit of the buffer resource volume 263 to the third-lowest ranked (e.g., third-highest probability) incremental probability 404a, etc.

In some embodiments, the total buffer resource volume 263 may be incrementally allocated until all units of the total buffer resource volume 263 have been allocated. For example, FIG. 8B includes ten incremental probabilities. If the total buffer resource volume 263 includes ten or more units of the selected resource, each of the demand nodes 84a-84c may receive a buffer resource allocation equal to the number of incremental probabilities generated for that demand node 84a-84c. Conversely, if the total buffer resource volume 263 includes less than ten units of the selected resource, the demand nodes 84a-84c having the lowest incremental probabilities may not receive allocation of buffer resources for those probabilities (e.g., if there are nine units in the total buffer resource volume 263, the third demand node 84c receives only two units of the resource allocated as a buffer resource, and the lowest incremental probability 406c is ignored).

In some embodiments, a constraint (e.g., cutoff) threshold may be determined for the incremental probabilities 402 such that an incremental probability less than the constraint threshold is ignored for purposes of buffer resource allocation. For example, in some embodiments, an acceptable stockout rate may be determined based on historical stockout and/or buffer values for a corresponding demand node 84a-84c. The acceptable stockout rate may correspond to a probability of stockout, a number of units, etc. In some embodiments, the constraint threshold is determined based on the total number of units available for safety stock allocation and/or allowed to be held as safety stock allocation across all demand nodes 84a-84c served by a current distribution node 82a.

For example, in the embodiment of FIG. 8B, a constraint cutoff threshold is illustrated by a threshold cutoff line 412. The threshold cutoff line 412 is positioned such that the number of probabilities below the threshold cutoff line 412 is equal to the number of available safety stock units for a current resource. For example, in the illustrated embodiment, the number of available safety stock units is six and there are six incremental probabilities 402a, 402b, 404a, 402c, 404b, 406a positioned below the threshold cutoff line 412 and four incremental probabilities 402d, 406b, 404c, 406c positioned above the threshold cutoff line 412. In the embodiment of FIG. 8B, safety stock is allocated to the associated demand nodes 84a-84c only for the six incremental probabilities 402a, 402b, 404a, 402c, 404b, 406a positioned below the threshold cutoff line 412.

In some embodiments, a threshold value for use in marginal analysis is based on the constraint cutoff threshold (e.g., the position of the threshold cutoff line 412). A threshold parameter λ is determined based on an aggregation (e.g., average) of the lowest probability of stockout below the cutoff threshold (e.g., stockout probability 406a in FIG. 8B) and the highest probability of stockout above the cutoff threshold (e.g., incremental probability 402d in FIG. 8B). In the illustrated embodiment, the threshold parameter A is equal to the average of the incremental probability 406a and incremental probability 402d, e.g.,

$$λ = \frac{0.38 + 0.44}{2} = 0.41 .$$

Although specific embodiments are discussed herein, it will be appreciated that λ may have any suitable value based on the stockout probabilities that are closest to the constraint cutoff threshold (e.g., immediately above and below the threshold cutoff line 412).

In some embodiments, a threshold parameter λ may be used to determine stockout allocation without needing to rank or filter all of the corresponding stockout probabilities for each demand node 84a-84c. For example, once a threshold parameter λ is determined, any stockout probability greater than the threshold parameter A receives allocation of a buffer resource allocation of one unit and each stockout probability less than the threshold parameter A is ignored (e.g., does not receive a buffer resource allocation).

In some embodiments, the buffer resource allocation quantities 276, the constraint cutoff threshold, and/or the threshold parameter A may each represent a proxy for an acceptable stockout rate. Initial values for the acceptable stockout rate may be determined based on historical resource usage, stockout rates, business rules, domain expertise, etc. For example, in some embodiments, the constraint cutoff threshold is determined by historical median buffer resource values and/or other historically defined constraints. A historically determined constraint cutoff threshold may be applied to determine a threshold cutoff line 412 position, as discussed above, and the threshold parameter A may be determined from the stockout probabilities immediately adjacent to the threshold cutoff line 412. Although specific embodiments are discussed herein, it will be appreciated that the constraint cutoff threshold and/or the threshold parameter/may be determined using any suitable process and/or data.

In some embodiments, the buffer resource allocation quantities 276 may be subdivided into smaller time increments as compared to the periods used to calculate the buffer resource allocation quantities 276. For example, if buffer resource allocation quantities 276 are determined for weekly lead periods, each of the buffer resource allocation quantities 276 may be divided into smaller increments, such as daily buffer resource allocation quantities. A conversion factor, such as an average forecasted daily resource use rate over a predetermined period and/or historical resource use rates may be used to convert the buffer resource allocation quantities 276 into smaller increments, such as days of supply (DOS) increments. The generation of smaller increments, such as DOS increments, enables the buffer resource allocation quantities 276 to accommodate seasonal demand shoulders, e.g., periods during which the demand of one or more resources shifts or changes.

In some embodiments, an aggregate fill rate may be maximized while constraining a total amount of a resource maintained by each of the demand nodes 84a-84c. The total amount of resource maintained may be measured in a period of supply (POS), e.g., days of supply, hours of supply, etc. The period of supply represents the number of a specific period (e.g., days, hours) over which the corresponding resource is expected to be utilized (e.g., sold, consumed, etc.). A network-wide POS target may be set and applied to all distribution nodes 82 in the target network 80. As discussed in greater detail above, the distribution node-specific period of supply may be allocated to each individual demand node 84a-84c serviced by the corresponding distribution node 82a.

With reference again to FIGS. 3-4, at step 212, one or more of the buffer resource allocation quantities 276 may be modified based on one or more applied rules. For example, in some embodiments, a minimum and/or maximum buffer volume for a selected resource may be determined and/or enforced by one or more rules. If one of the buffer resource allocation quantities 276 is above a maximum buffer volume or below a minimum buffer volume, a rules engine may apply a rule that adjusts the corresponding buffer resource allocation rate to the maximum buffer or minimum buffer volume, as appropriate. As another example, in some embodiments, a maximum buffer utilization may be determined for one or more demand nodes 84a-84c such that if any of the demand nodes 84a-84c are utilizing a buffer volume equal to or about the maximum buffer utilization, the number of buffer resource allocations, e.g., the number of stockout events in a probability distribution that are allocated with a buffer resource, may be capped to prevent resource deficiencies at other demand nodes 84a-84c serviced by the corresponding distribution node 82a. It will be appreciated that any suitable rules may be applied to adjust the buffer resource allocation quantities. The one or more rules may be applied by any suitable process, system, engine, etc., such a rules-engine implemented by the node analysis module 272.

At step 214, buffer resource data structure 274 may be stored in any suitable storage mechanism, such as a database 14, and/or utilized for one or more additional processes or methods. For example, in some embodiments, the buffer resource data structure 274 may be utilized in conjunction with one or more supply chain control processes configured to implement resource allocation within a supply chain represented by the target network 80. As another example, in some embodiments, the buffer resource data structure 274 is utilized in conjunction with a simulation process configured to simulate and/or predict operation of the target network 80. As yet another example, in some embodiments, the buffer resource data structure 274 may be provided to one or more review processes.

At optional step 216, feedback data 290 is received. The feedback data 290 may be related to one or more processes executed utilizing and/or in conjunction with the buffer resource data structure 274 and/or may be related to one or more data elements utilized to generate the buffer resource data structure 274. For example, the feedback data 290 may include simulation results and/or deployment results including stockout event rates for the target network 80 based on utilization of the buffer resource data structure 274 to determine buffer resource volumes within one or more of the demand nodes 84 of the target network 80. As another example, in some embodiments, the feedback data 290 may include additional and/or updated resource exhaustion signals 270 related to the demand nodes 84a-84c represented in the buffer resource data structure 274. Although specific embodiments are discussed herein, it will be appreciated that any suitable feedback data 290 may be received by the resource buffer optimization engine 258.

In some embodiments, the feedback data 290 may be utilized to generate a new and/or updated buffer resource data structure 274. For example, the feedback data 290 may be utilized to update network data 254, network-wide parameters 260, distribution node specific parameters 262, resource exhaustion signals 270, and/or any other suitable data inputs. The buffer resource data structure 274 previously generated may be utilized to provide one or more elements, such as a threshold parameter 2. New and/or updated buffer resource data structures 274 may be generated upon receipt of feedback data 290, at predetermined intervals, and/or in response to any suitable trigger.

The disclosed systems and methods provide demand node-specific optimized buffer resource values for each resource based on a determined distribution node buffer resource allocation. The disclosed systems and methods provide an improved systems that minimizes buffer resource allocations while maintaining a manageable number of targets and gaining the benefit of customized demand node-specific allocations. The disclosed systems and methods apply a systematic approach utilizing, for example, marginal analysis to minimize a probability of a stockout even across all demand nodes in a target network while meeting one or more resource constraints for the target network 80.

It will be appreciated that node-specific optimized buffer resource allocations and simulations of target networks based on optimized buffer resource allocations as disclosed herein, particularly for large networks such as large-scale supply chain networks, is only possible with the aid of computer-assisted algorithms and techniques, such as the use of a buffer optimization engine and the corresponding modules disclosed herein. In some embodiments, processes executed by and/or configured to implement one or more applicable modules, such as a demand estimation module and/or a node analysis module, are used to perform operations that cannot practically be performed by a human, either mentally or with assistance, such as buffer resource allocation for large scale distribution networks.

In some embodiments, a buffer optimization engine can include and/or implement one or more trained models, such as a machine learning model configured to determine one or more node-specific parameters, such as one or more node-specific demand distributions 268. In some embodiments, one or more trained models can be generated using an iterative training process based on a training dataset.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a resource buffer optimization request for at least one distribution node and a plurality of demand nodes associated with the at least one distribution node for a selected resource;
determine a demand probability distribution including probabilities of one or more marginal stockout events for each of the plurality of demand nodes;
rank the one or more marginal stockout events for each of the plurality of demand nodes in a combined ranking;
determine a constraint cutoff threshold;
generate a resource buffer data structure including demand node resource buffer allocations for each of the plurality of demand nodes, wherein each of the demand node resource buffer allocations include a marginal stockout event having a probability greater than or equal to the constraint cutoff threshold; and
store the resource buffer data structure in a data store.

2. The system of claim 1, wherein the demand probability distribution comprises a probability mass function.

3. The system of claim 2, wherein a first probability distribution is applied when a first set of parameters are met and a second probability distribution is applied when the first set of parameters are not met.

4. The system of claim 3, wherein the first probability distribution is a negative binomial distribution and the second probability distribution is a Poisson distribution.

5. The system of claim 3, wherein the first set of parameters comprises a comparison of a mean and a variance.

6. The system of claim 1, wherein the resource buffer data structure is generated, in part, by applying marginal reduction analysis to the probability associated with each of the one or more marginal stockout events.

7. The system of claim 1, wherein the constraint cutoff threshold is determined, at least in part, based on historical stockout data for each of the plurality of demand nodes.

8. The system of claim 1, wherein the constraint cutoff threshold is determined, at least in part, by one of a network-wide parameter, a distribution-node specific parameter, or each of the network-wide parameter and the distribution-node specific parameter.

9. A computer-implemented method, comprising:
receiving a resource buffer optimization request for at least one distribution node and a plurality of demand nodes associated with the at least one distribution node for a selected resource;
determining a demand probability distribution including probabilities of one or more marginal stockout events for each of the plurality of demand nodes;
ranking the one or more marginal stockout events for each of the plurality of demand nodes in a combined ranking;
determining a constraint cutoff threshold;
generating a resource buffer data structure including demand node resource buffer allocations for each of the plurality of demand nodes, wherein each of the demand node resource buffer allocations include a marginal stockout event having a probability greater than or equal to the constraint cutoff threshold; and
storing the resource buffer data structure in a data store.

10. The computer-implemented method of claim 9, wherein the demand probability distribution comprises a probability mass function.

11. The computer-implemented method of claim 10, wherein a first probability distribution is applied when a first set of parameters are met and a second probability distribution is applied when the first set of parameters are not met.

12. The computer-implemented method of claim 11, wherein the first probability distribution is a negative binomial distribution and the second probability distribution is a Poisson distribution.

13. The computer-implemented method of claim 11, wherein the first set of parameters comprises a comparison of a mean and a variance.

14. The computer-implemented method of claim 9, wherein the resource buffer data structure is generated, in part, by applying marginal reduction analysis to the probability associated with each of the one or more marginal stockout events.

15. The computer-implemented method of claim 9, wherein the constraint cutoff threshold is determined, at least in part, based on historical stockout data for each of the plurality of demand nodes.

16. The computer-implemented method of claim 9, wherein the constraint cutoff threshold is determined, at least in part, by one of a network-wide parameter, a distribution-node specific parameter, or each of the network-wide parameter and the distribution-node specific parameter.

17. A non-transitory computer-readable medium having instructions stored thereon, wherein the instructions, when executed by at least one processor, cause at least one device to perform operations comprising:
receiving a resource buffer optimization request for at least one distribution node and a plurality of demand nodes associated with the at least one distribution node for a selected resource;
determining a demand probability distribution comprising a probability mass function including probabilities of one or more marginal stockout events for each of the plurality of demand nodes;
ranking the one or more marginal stockout events for each of the plurality of demand nodes in a combined ranking;
determining a constraint cutoff threshold;
generating a resource buffer data structure including demand node resource buffer allocations for each of the plurality of demand nodes, wherein each of the demand node resource buffer allocations include a marginal stockout event having a probability greater than or equal to the constraint cutoff threshold; and
storing the resource buffer data structure in a data store.

18. The non-transitory computer-readable medium of claim 17, wherein a first probability distribution is applied when a first set of parameters are met and a second probability distribution is applied when the first set of parameters are not met.

19. The non-transitory computer-readable medium of claim 18, wherein the first probability distribution is a negative binomial distribution and the second probability distribution is a Poisson distribution, and wherein the first set of parameters comprises a comparison of a mean and a variance.

20. The non-transitory computer-readable medium of claim 17, wherein the resource buffer data structure is generated, in part, by applying marginal reduction analysis to the probability associated with each of the one or more marginal stockout events.
